(19) United States
(12) Patent Application Publication
(10) Pub. No.: US 2011/0087462 A1
(43) Pub. Date: Apr. 14, 2011

(54) COMPACT, COMPONENTIZED HARDWARE ARCHITECTURE AND REFERENCE PLATFORM FAMILY FOR LOW-POWER, LOW-COST, HIGH-FIDELITY IN SITU SENSING

(76) Inventor: Jason O. Hallstom, Central, SC (US)

(21) Appl. No.: 12/904,747

(22) Filed: Oct. 14, 2010

Related U.S. Application Data
(60) Provisional application No. 61/251,463, filed on Oct. 14, 2009.

(51) Int. Cl. G06F 15/00

(52) U.S. Cl. 702/188

(57) ABSTRACT

Described herein are embodiments of a hardware architecture and reference platform family for constructing large-scale, long-lived, wireless data acquisition networks. Embodiments of the device are designed to enable data collection, data processing, data storage, and data communication across a broad range of sensor, storage, and communication technologies. When deployed at scale, the devices form an intelligent sensing fabric that can cover a large geographic area with minimal power requirements at a low cost. While the architecture was originally conceived to suit the requirements of the Intelligent River™ program, the architecture and its platform realizations provide value to a range of industry segments, from agriculture and utilities to defense and manufacturing. For example, embodiments of the described invention can be used in applications such as resource management, smart transportation, precision agriculture, habitat monitoring, wildfire tracking, threat detection, smart structures, smart energy, smart-grids, etc.

### CROSS REFERENCE TO RELATED APPLICATION

This application claims benefit of and priority to U.S. Provisional Patent Application Ser. No. 61/251,463 filed Oct. 14, 2009, which is fully incorporated herein by reference and made a part hereof.

### GOVERNMENT SUPPORT CLAUSE

This invention was made with government support under CNS-0745846 awarded by The US National Science Foundation, 4201 Wilson Boulevard, Arlington, Va. 22230. The government has certain rights in the invention.

### BACKGROUND

A sensor node, also known as a “mote,” is a node in a wireless sensor network that is capable of performing some processing, gathering sensory information and communicating with other connected nodes in the network. Typical architecture of a mote is shown in FIG. 1 and is generally comprised of a micro-controller unit (MCU) 102, an analog to digital convertor (ADC) 104, one or more sensors 106, a memory 108, a transceiver 110, and a power source 112.

Generally, though, prior-art motes are inflexible in their configuration, lack a number of features including the ability to accommodate multiple communications paths and digital sensor interfaces (in particular, SDI-12), and lack adequate power control for a wide range of peripherals (e.g., sensors). Further, these issues lead to faster power source depletion and more expensive data collection.

Therefore, what are needed are motes that overcome challenges in the art, some of which are described above, and methods of using them.

### SUMMARY

Described herein are embodiments of a hardware architecture and reference platform family for constructing large-scale, long-lived, wireless data acquisition networks. Embodiments of the device are designed to enable data collection, data processing, data storage, and data communication across a broad range of sensor, storage, and communication technologies. When deployed at scale, the devices form an intelligent sensing fabric that can cover a large geographic area with minimal power requirements at a low cost. While the architecture was originally conceived to suit the requirements of the Intelligent River™ program, the architecture and its platform realizations provide value to a range of industry segments, from agriculture and utilities to defense and manufacturing. For example, embodiments of the described invention can be used in applications such as resource management, smart transportation, precision agriculture, habitat monitoring, wildfire tracking, threat detection, smart structures, smart energy, smart-grids, etc.

Generally, device architecture of the embodiments is based on a stackable design. A wide electrical interconnect routes all power and processor signals vertically from the base of the stack through the supporting board layers. Site-specific device customizations are achieved by composing board layers that provide the desired services (e.g., MicroSD storage, cellular service, SDI-12 connectivity). Fine-grained power management is an over-arching goal for each layer of the architecture. Embodiments of the disclosed invention can provide from over five months to over one year of operation on a single 9v battery.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating typical architecture of a mote;

FIGS. 2a-2d illustrate one embodiment of a stackable mote comprising a processor board (FIG. 2a), an interface board (FIG. 2b), and a radio board (FIG. 2c), and FIG. 2d shows an assembled reference platform composed by stacking the three layers;

FIG. 3a illustrates a layout diagram of an embodiment of an exemplary processor board that can be used in an embodiment of a stackable mote;

FIG. 3b illustrates an electrical schematic for the embodiment of processor board shown in FIG. 3a;

FIG. 3c is an exemplary bill of materials for the embodiment of a processor board shown in FIGS. 3a and 3b;

FIG. 4a illustrates a layout diagram of an embodiment of an exemplary interface board that can be used in an embodiment of a stackable mote;

FIG. 4b illustrates an electrical schematic for the embodiment of an interface board shown in FIG. 4a;

FIG. 4c is an exemplary bill of materials for the embodiment of an interface board shown in FIGS. 4a and 4b;

FIG. 5a illustrates a layout diagram of an embodiment of an exemplary radio board that can be used in an embodiment of a stackable mote;

FIG. 5b illustrates an electrical schematic for the embodiment of a radio board shown in FIG. 5a;

FIG. 5c is an exemplary bill of materials for the embodiment of a radio board shown in FIGS. 5a and 5b;

FIG. 6a illustrates a layout diagram of an embodiment of an exemplary storage board that can be used in an embodiment of a stackable mote;

FIG. 6b illustrates an electrical schematic for the embodiment of a storage board shown in FIG. 6a;

FIG. 6c is an exemplary bill of materials for the embodiment of a storage board shown in FIGS. 6a and 6b;

FIG. 7 is a pin-out chart for an embodiment of a processor that illustrates the interconnectivity between the various boards that comprise an embodiment of a stackable mote;

FIG. 8 is a block diagram illustrating an exemplary operating environment for performing the disclosed methods; and

FIGS. 9a-9e illustrate one embodiment of a stackable mote comprising a processor board (FIG. 9a), a storage board (FIG. 9b), and a radio board (FIG. 9c), an interface board (FIG. 9d), and FIG. 9e shows an assembled reference platform composed by stacking the four layers.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Described herein are embodiments of sensor nodes, or motes, that can be used in an in situ monitoring network and system such as, for example the Intelligent River™ project, an end-to-end hardware/software infrastructure engineered to support real-time monitoring and management of water resources across the state of South Carolina. In the Intelligent River™ project, the sensing fabric comprises a range of heterogeneous devices. While the system could be simplified by adopting a single hardware platform, doing so would limit the set environmental and hydrological parameters that could be captured and would couple the system to a particular technology provider. Hence, a range of sensing platforms are deployed—from standard mote-class devices to commercial data loggers to custom platforms designed to improve configurability and cut costs. Described herein are embodiments of custom platforms that comprise a compact, componentized hardware architecture and reference platform family for low-power, low-cost, high-fidelity in situ sensing.

Design features for the described embodiments include: (i) support for multiple analog sensors, (ii) high-fidelity data sampling, (iii) inexpensive production, and (iv) design simplicity. Supplementary objectives addressed in the design embodiments described herein include (i) increased hardware configurability and programmability, (ii) improved power management, (iii) support for common digital sensor interfaces, and (iv) the addition of basic user interface elements.

The described embodiment boards can be stacked to enable application-specific customization. In the described embodiment, the monolithic structure common to commercial platforms is replaced in favor of a componentized architecture. By composing layers that provide basic services, site engineers can assemble a platform tailored to their specific deployment needs.

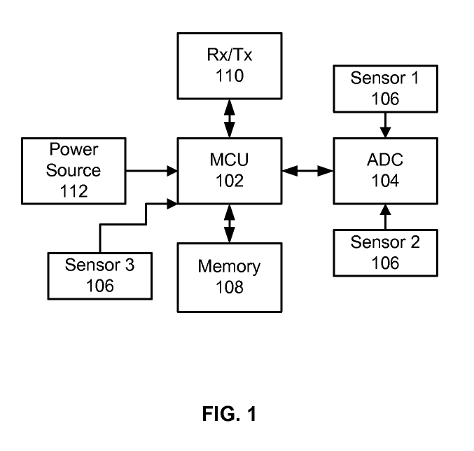

An exemplary block diagram of a mote is illustrated in FIG. 1. A microcontroller unit (MCU) 102 can be connected to several components. Each component can be placed on one or more circuit boards. The components of the mote can comprise but are not limited to at least one sensor 106, at least one analog-to-digital converter 104, a memory 108, a power source 112, memory, and a radio transmitter. In another aspect the components can comprise a radio transceiver 110.

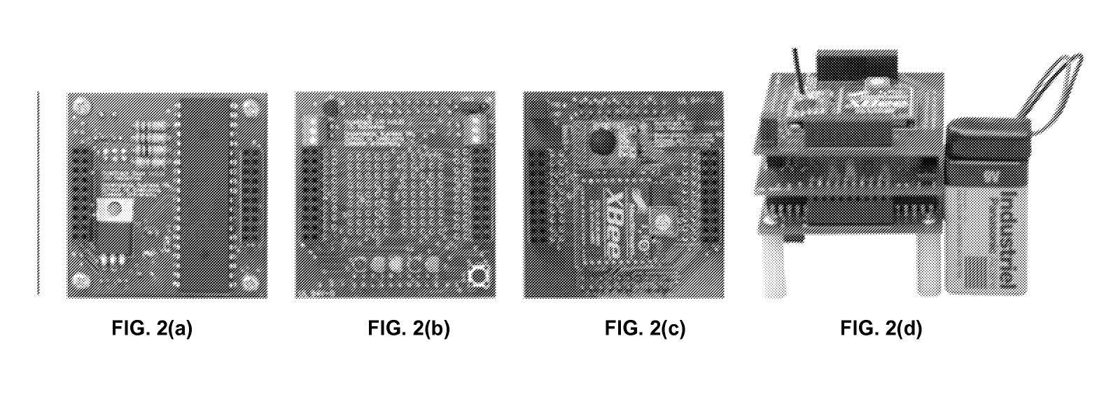

One embodiment of a stackable mote is shown in FIGS. 2a-2d comprising a processor board, an interface board, and a radio board. FIG. 2a shows the processor board. In addition to providing basic power regulation and noise filtering, the board hosts a general purpose microcontroller (MCU). For example, in the design shown in FIG. 2a, an AVR microcontroller with an integrated 10-bit ADC unit is used, though other MCUs may also be used. The standard 6-pin ISP header is exposed for device programming. FIG. 2b shows an interface board. In addition to providing basic user interface elements (e.g., LEDs, tactile switches, headers, etc.), the board can expose standard digital interfaces (e.g., I²C, SPI, 1-Wire, etc.) for attaching external components and sensors. Power gating circuitry can also be included to provide improved energy conservation during idle periods. FIG. 2c shows an embodiment of a radio board. Various wireless communications technologies may be used in different radio board embodiments including, for example, 3G/4G cellular, Wi-Fi (IEEE 802.11n), ZigBee, Bluetooth, WiMAX, etc. the employed communication technology can be selected and configured for a stackable mote based on coverage, foliage, penetration, data rate, and topology characteristics due to their operating frequency, power constraints, and radio techniques. For a given technology, the radio configuration (e.g., transmission power, amplifiers, antenna, etc.) can be adjusted to a limited extent according to the network coverage, transport capacity, and packet reception requirements.

FIG. 2d shows an assembled reference platform composed by stacking the three layers (processor board, interface board, and radio board). Additional boards may be added as appropriate, for instance, to provide support for high capacity nonvolatile storage, an SDI-12 board for aquatic sensor connectors, a solar board to provide a power source, and a cellular radio board.

Stackable mote devices deployed in the field can be programmed to minor the functionality of single board motes; however, the power consumption profile is significantly improved: For example, the sampling period can be configured for any interval (e.g., 15 minutes), and the approximate duration of the sample and transmit phase can be 5 seconds or less. This can yield various duty cycles, resulting in low idle current draw, independent of the sensor configuration. Depending on the radio and sensor configuration, the device can operate for several months or more on a 9v battery.

### Board Details:

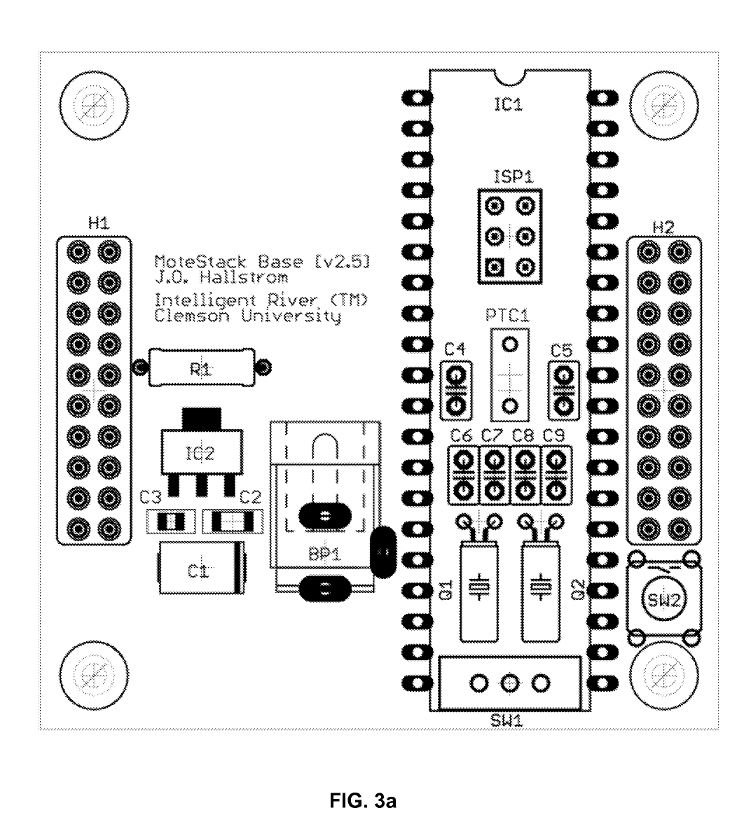

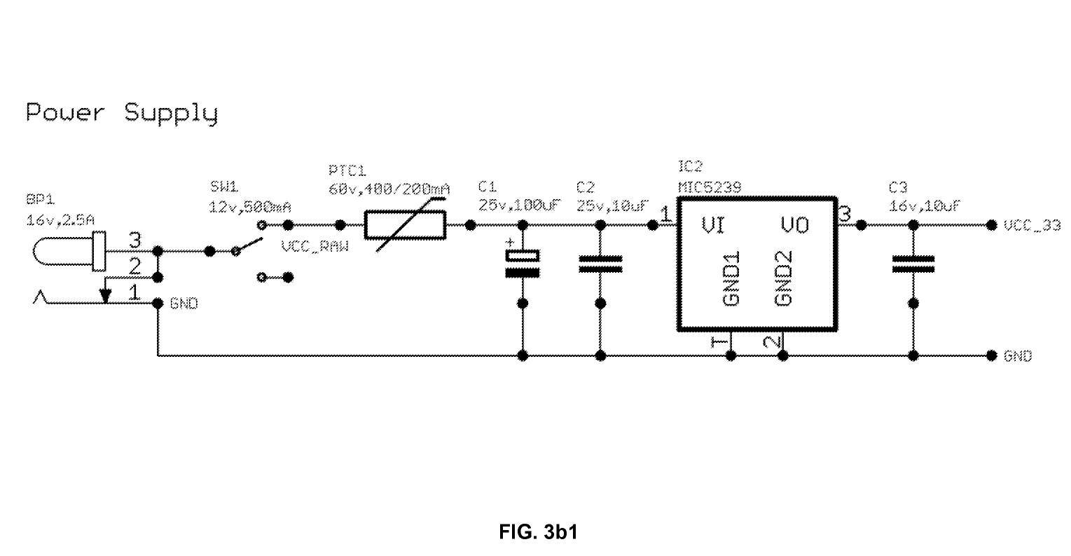

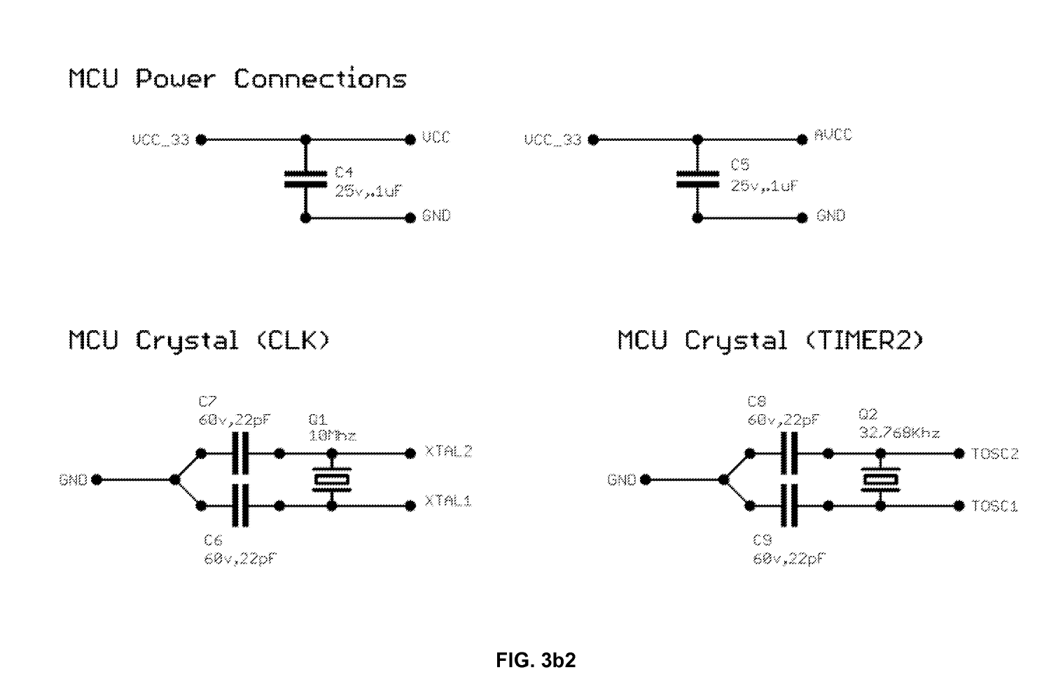

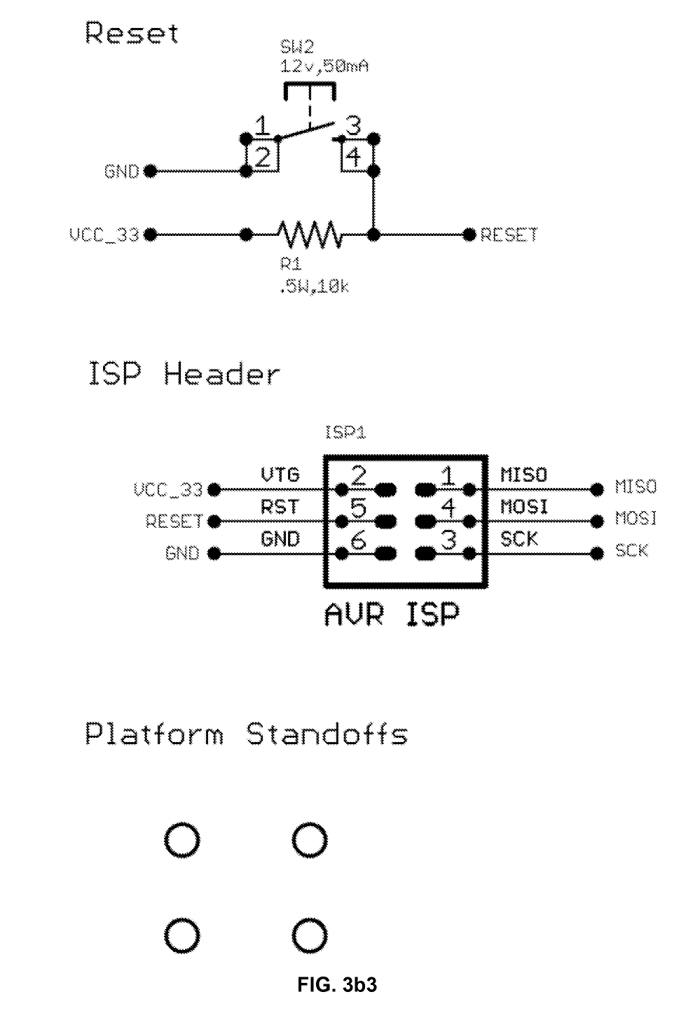

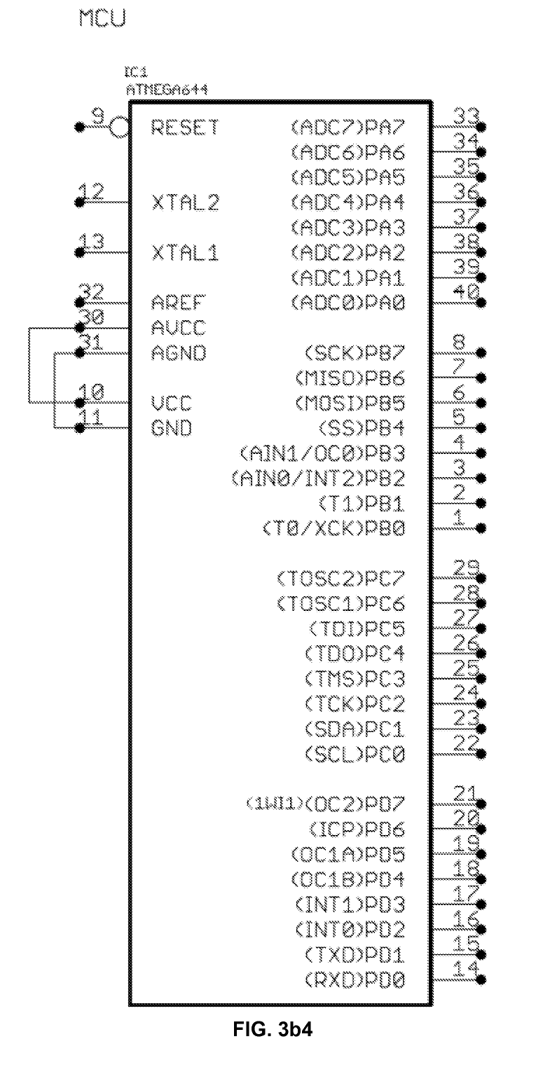

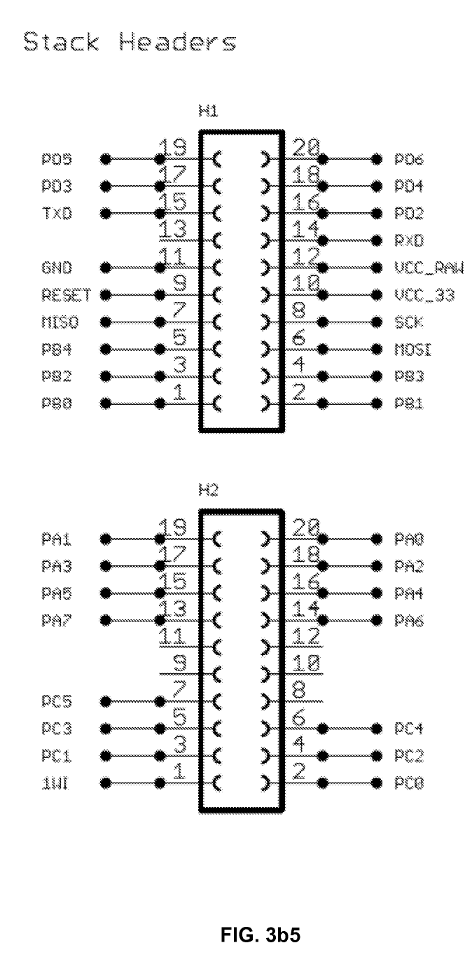

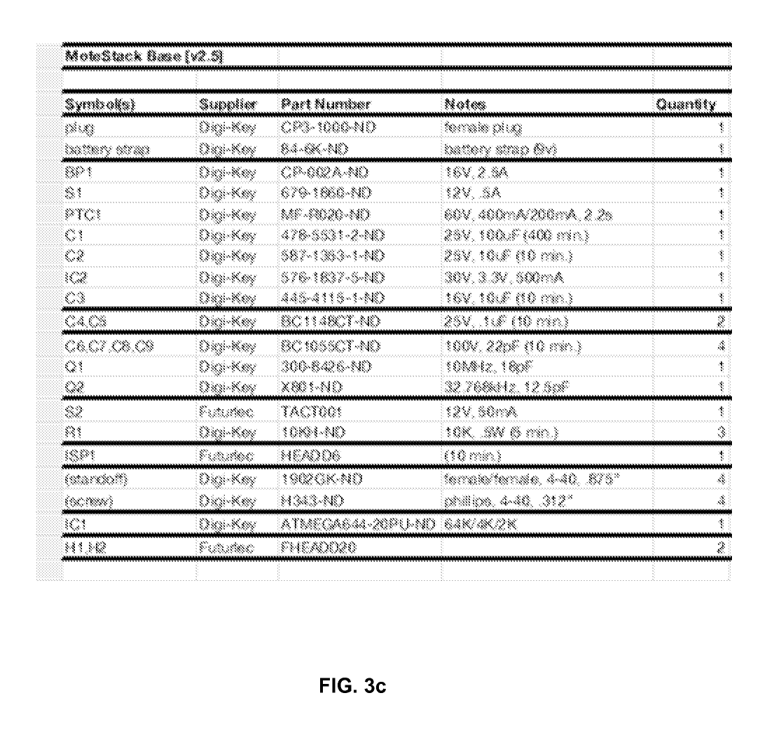

FIG. 3a illustrates a layout diagram of an embodiment of an exemplary processor board that can be used in an embodiment of a stackable mote. FIG. 3b illustrates an electrical schematic for the embodiment of processor board shown in FIG. 3a. FIG. 3c is an exemplary bill of materials for the embodiment of a processor board shown in FIGS. 3a and 3b. In one embodiment, the processor board comprises a 3.3V/5V regulated power supply (with protection), 64K ROM, 4K RAM (expandable), 2K flash memory (expandable), eight-10 bit ADC ports (expandable) and SPI, I²C, and I-Wire ports.

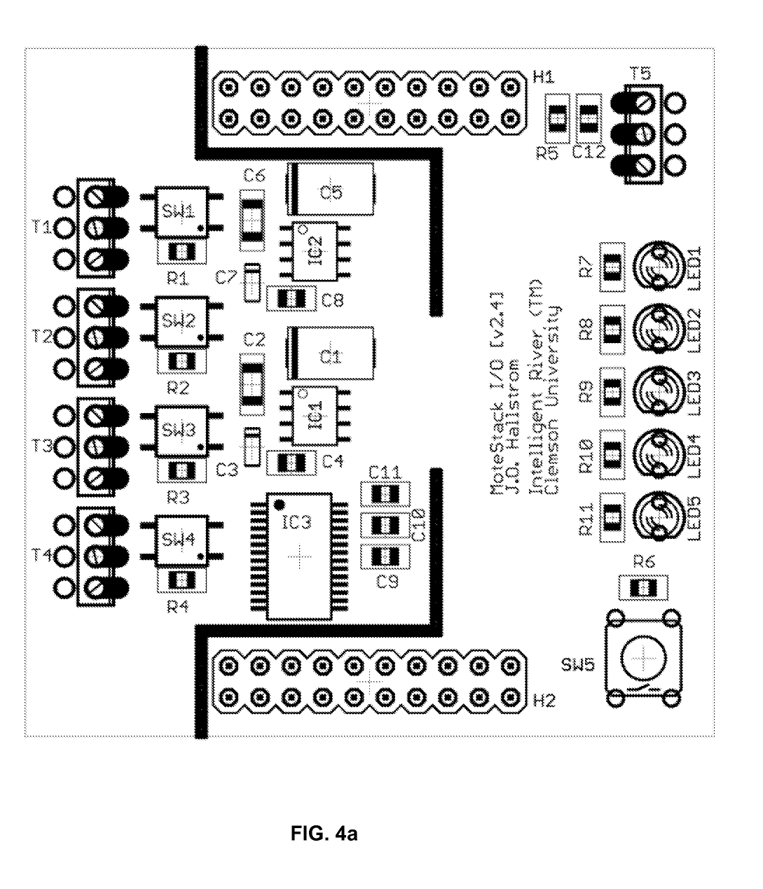

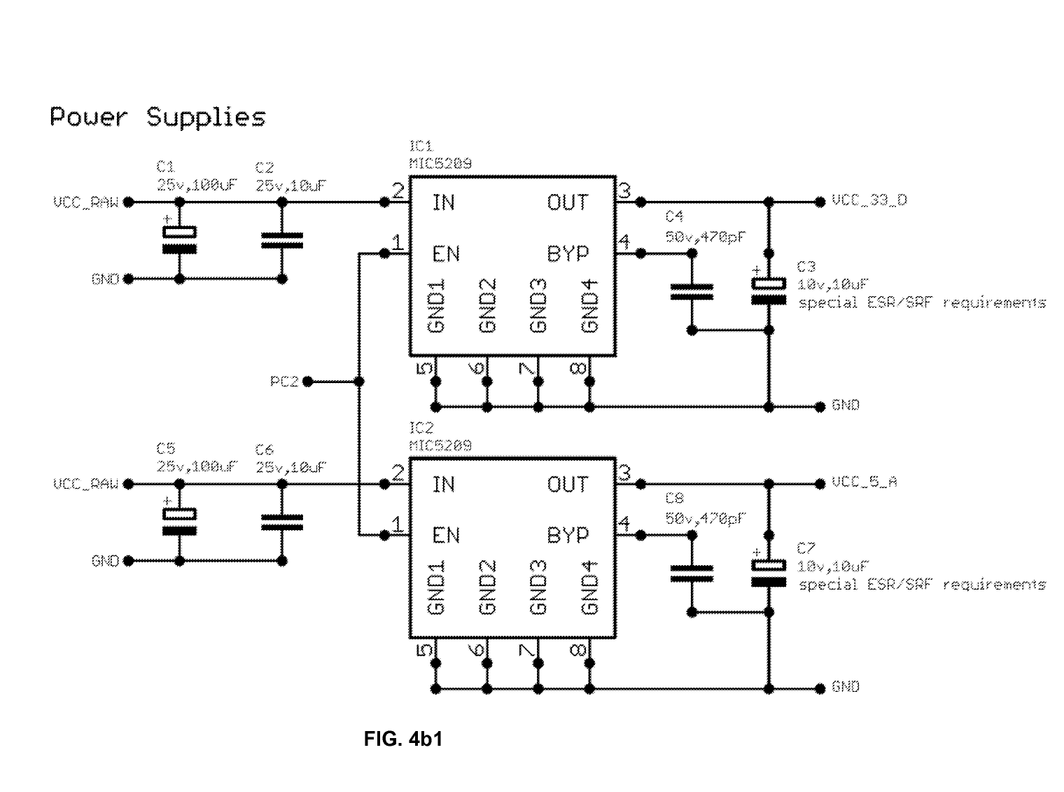

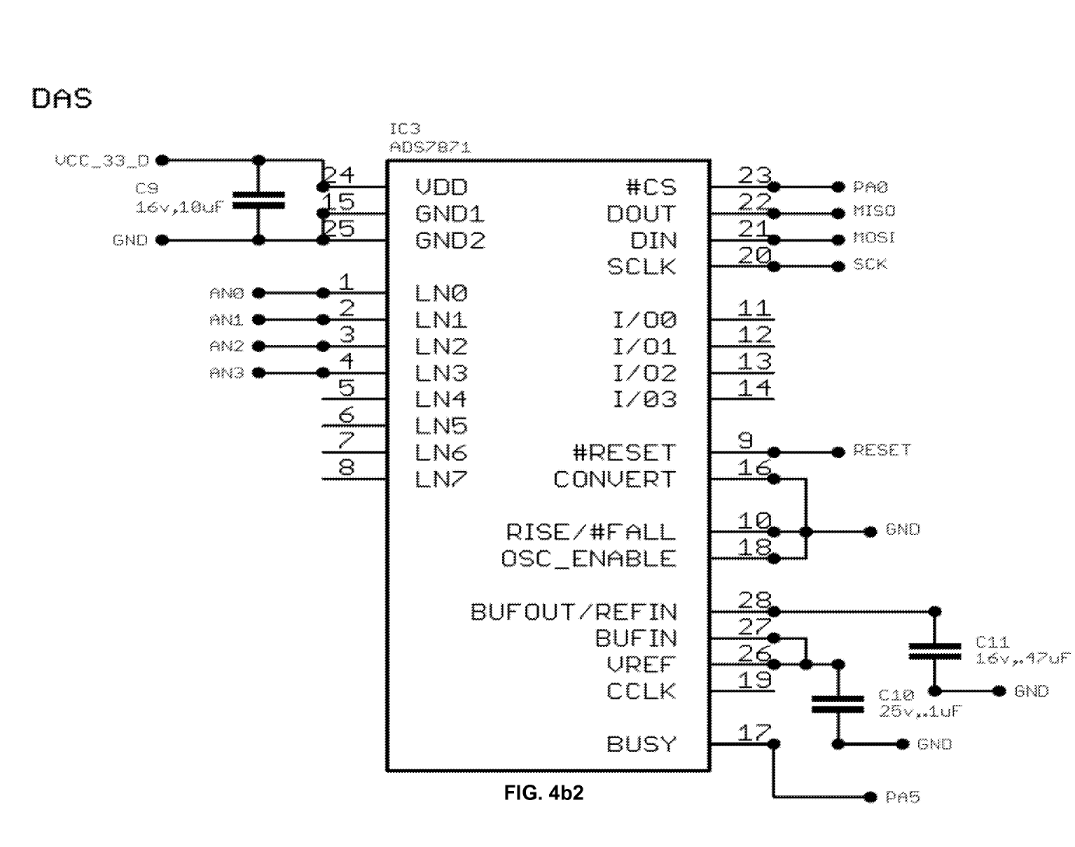

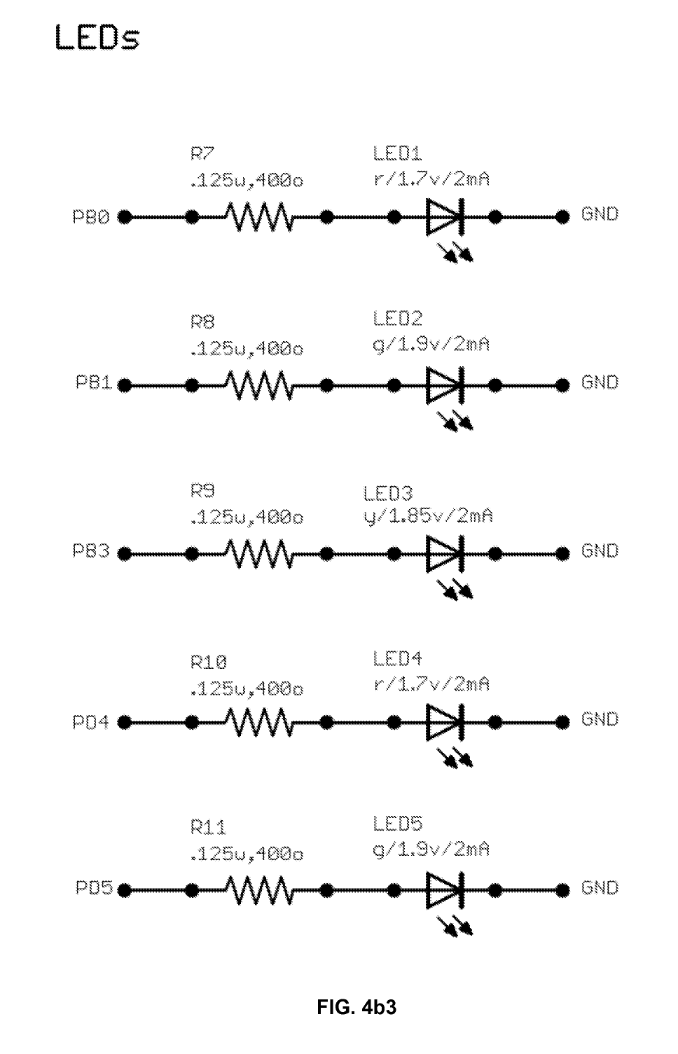

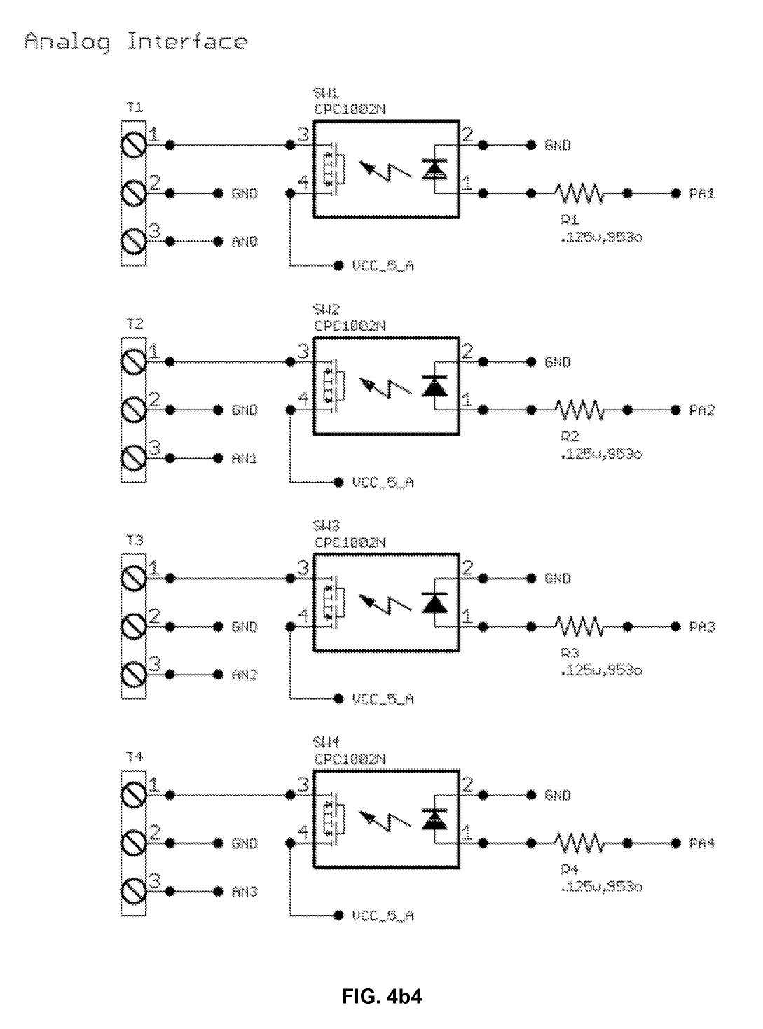

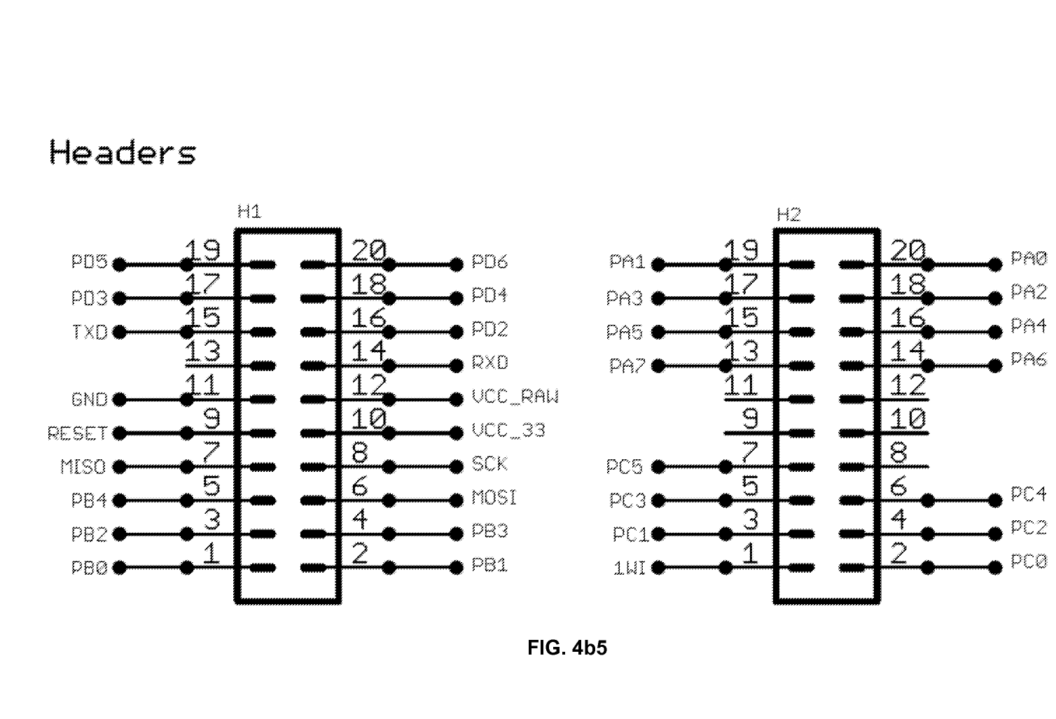

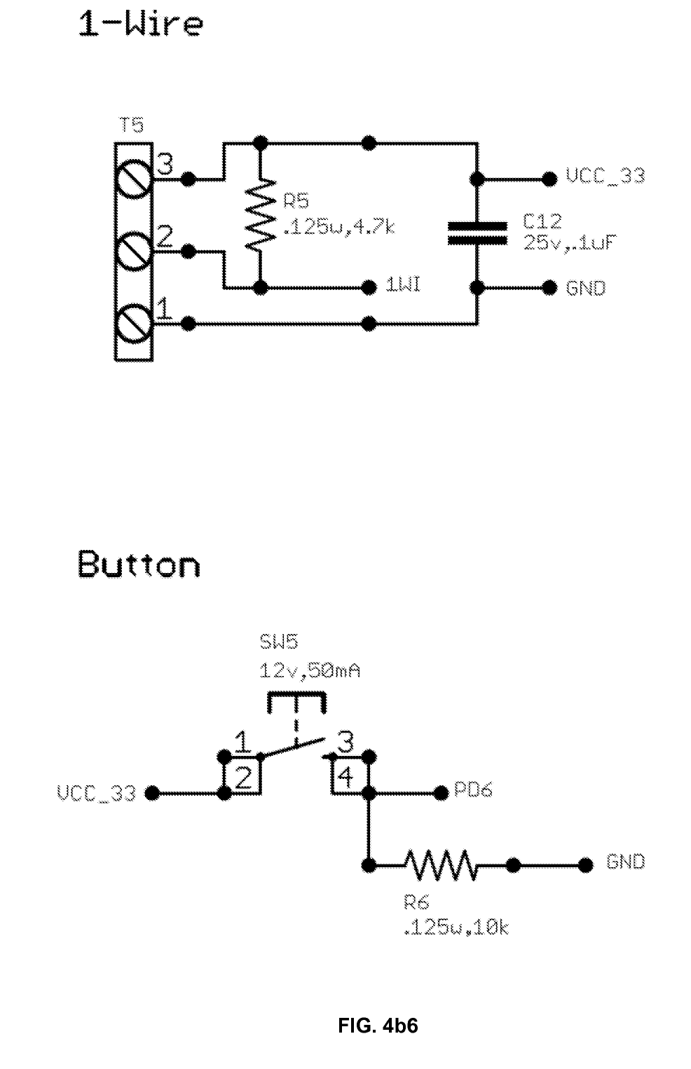

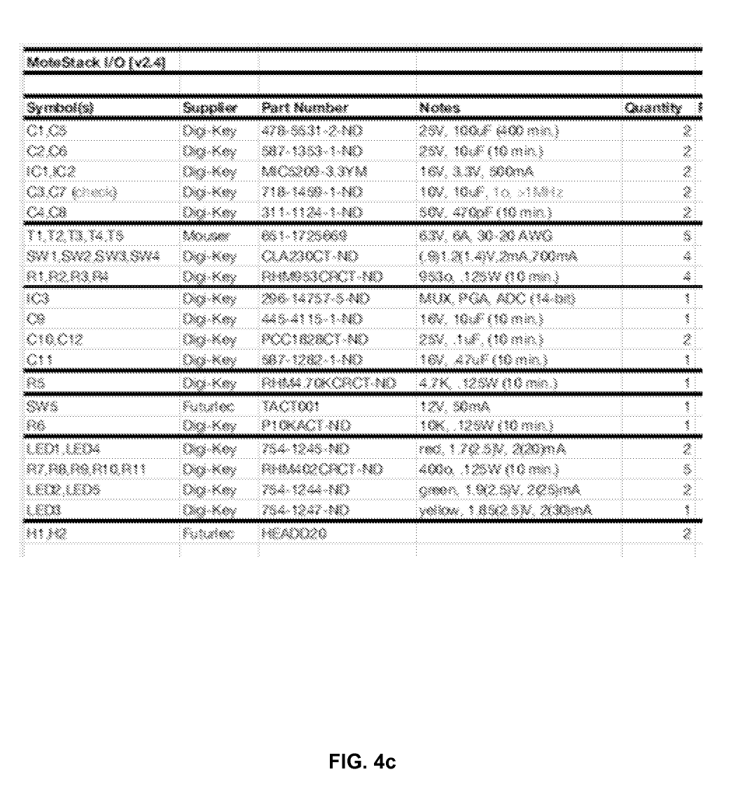

FIG. 4a illustrates a layout diagram of an embodiment of an exemplary interface board that can be used in an embodiment of a stackable mote. FIG. 4b illustrates an electrical schematic for the embodiment of an interface board shown in FIG. 4a. FIG. 4c is an exemplary bill of materials for the embodiment of an interface board shown in FIGS. 4a and 4b. In one embodiment, the interface board comprises LEDs, one or more tactile switches, power-gated sensor headers, 14-bit ADC, programmable gate amplifier (PGA), opto-isolated power gates, separate analog/digital regulators/ground planes and a one-wire header.

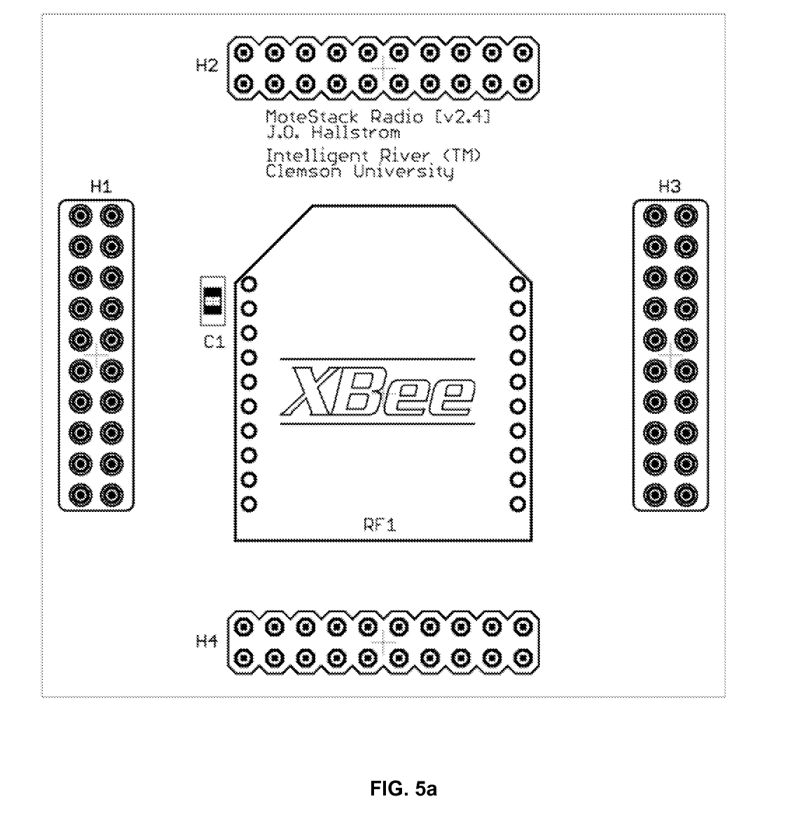

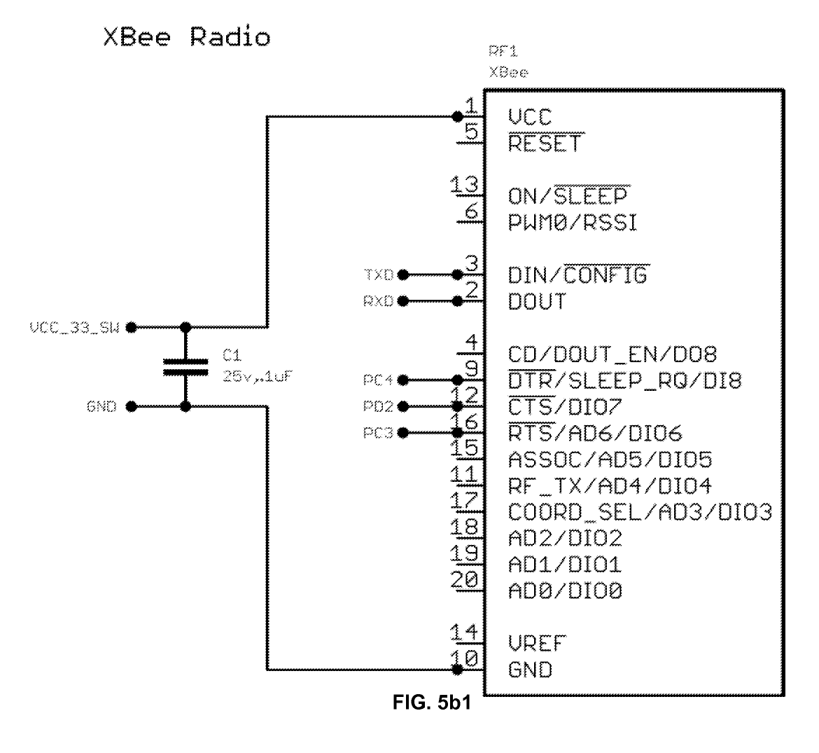

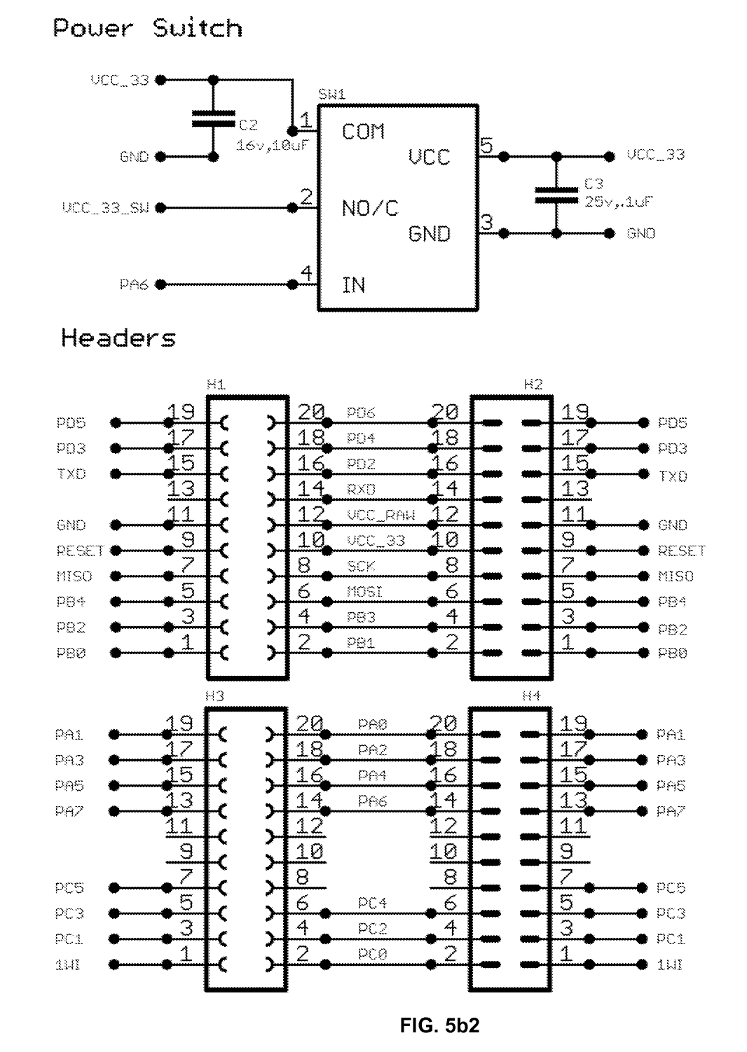

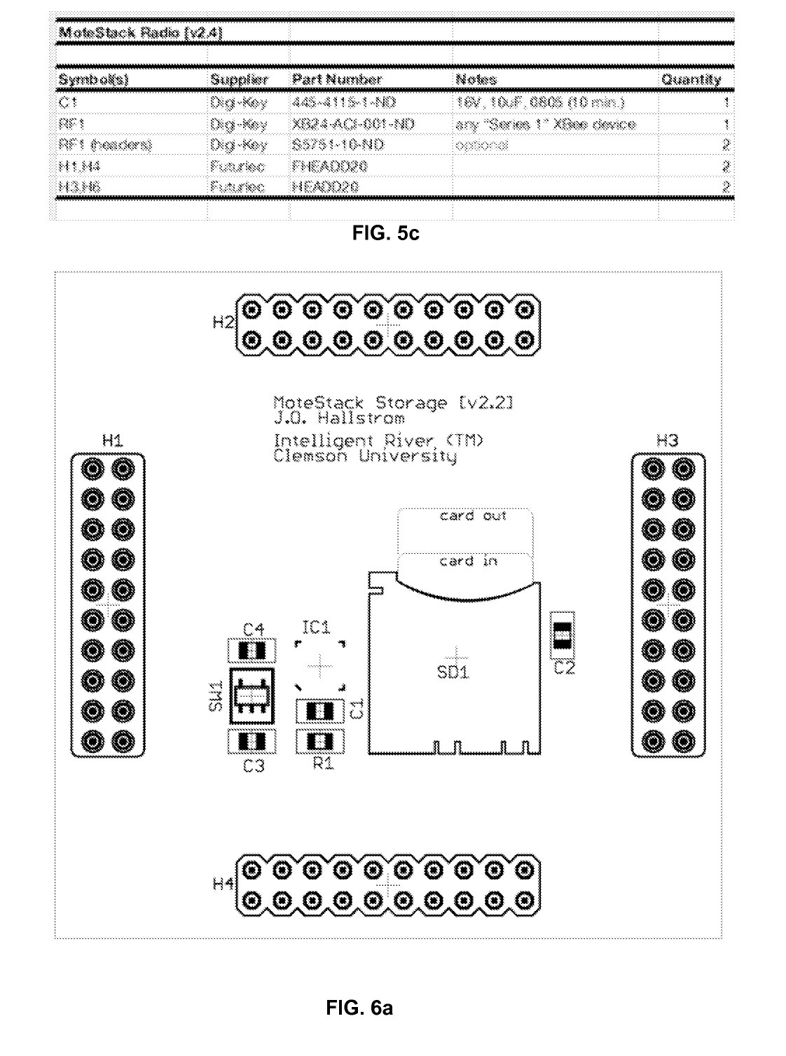

FIG. 5a illustrates a layout diagram of an embodiment of an exemplary radio board that can be used in an embodiment of a stackable mote. FIG. 5b illustrates an electrical schematic for the embodiment of a radio board shown in FIG. 5a. FIG. 5c is an exemplary bill of materials for the embodiment of a radio board shown in FIGS. 5a and 5b. In one embodiment, the radio board comprises an IEEE 802.15.4 ZigBee transceiver and optionally a 433 MHz (out of band) transceiver.

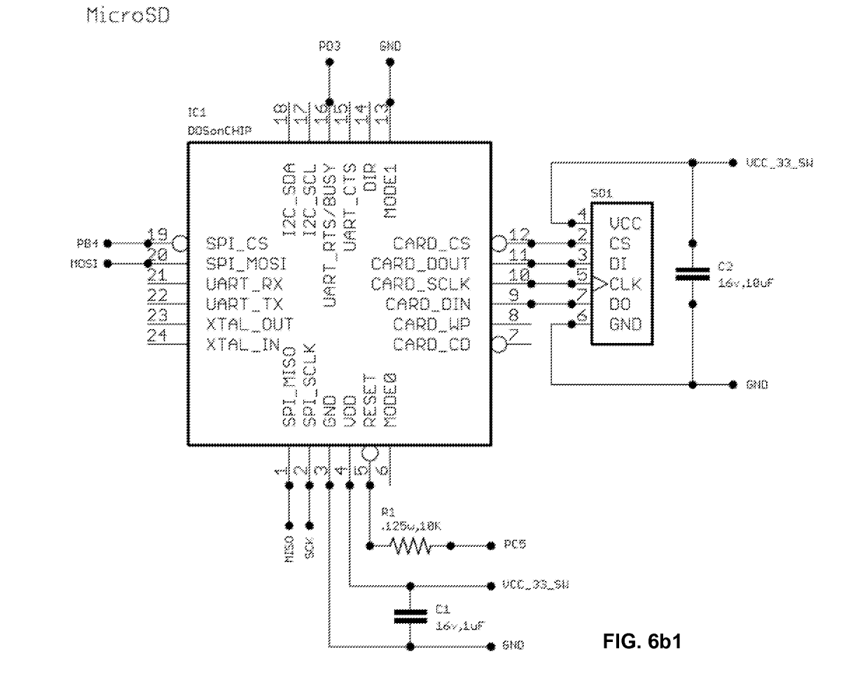

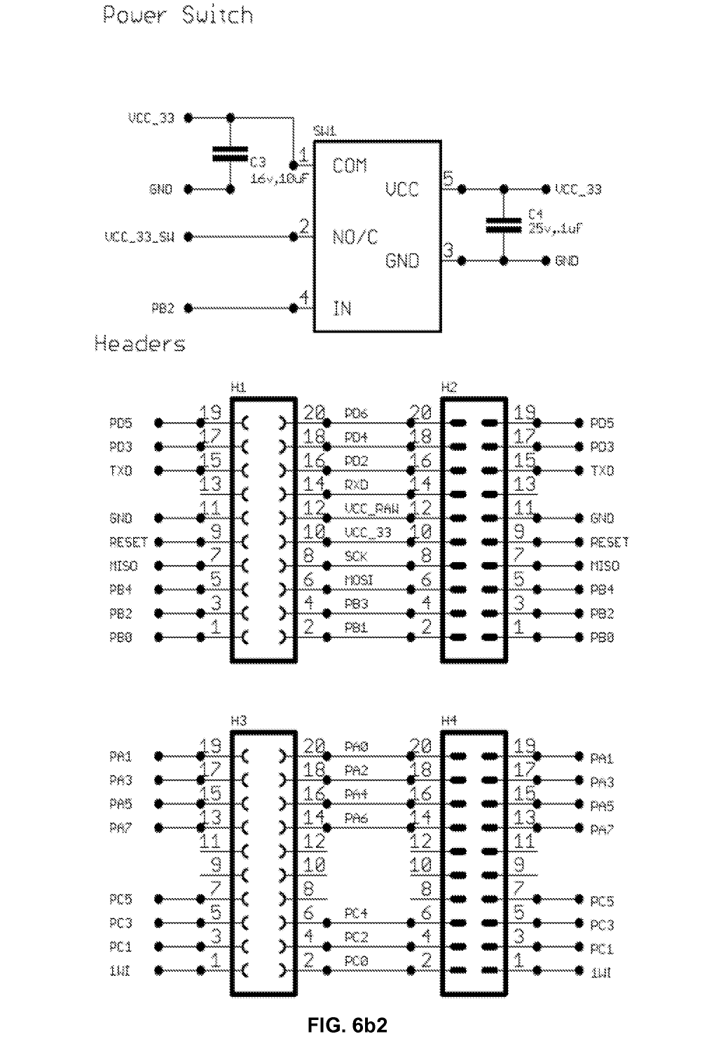

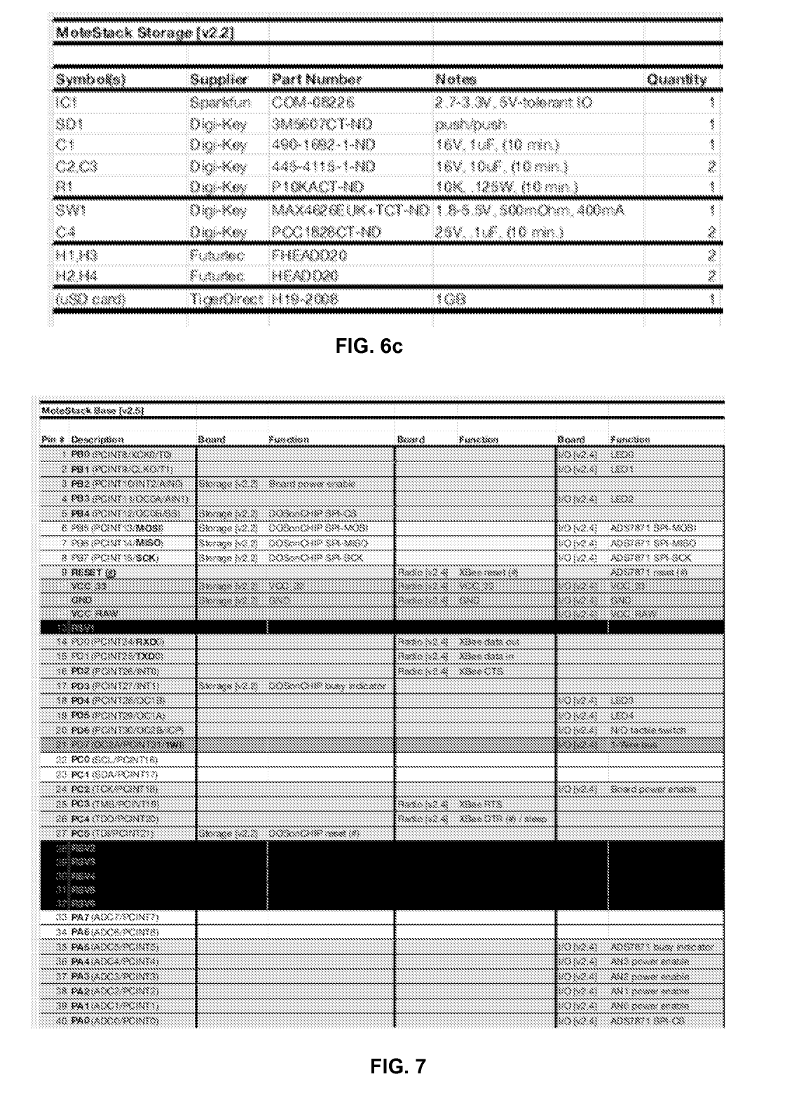

FIG. 6a illustrates a layout diagram of an embodiment of an exemplary storage board that can be used in an embodiment of a stackable mote. The storage board can be used to provide memory to a stackable mote such as, for example, high-capacity nonvolatile storage such as a 2 GB MicroSD. FIG. 6b illustrates an electrical schematic for the embodiment of a storage board shown in FIG. 6a. FIG. 6c is an exemplary bill of materials for the embodiment of a storage board shown in FIGS. 6a and 6b.

FIG. 7 is a pin-out chart for an embodiment of a processor (see FIG. 3b) that illustrates the interconnectivity between the various boards that comprise an embodiment of a stackable mote. In this example, the stackable mote is comprised of an interface (I/O) board, a radio board, processor board, and a storage board.

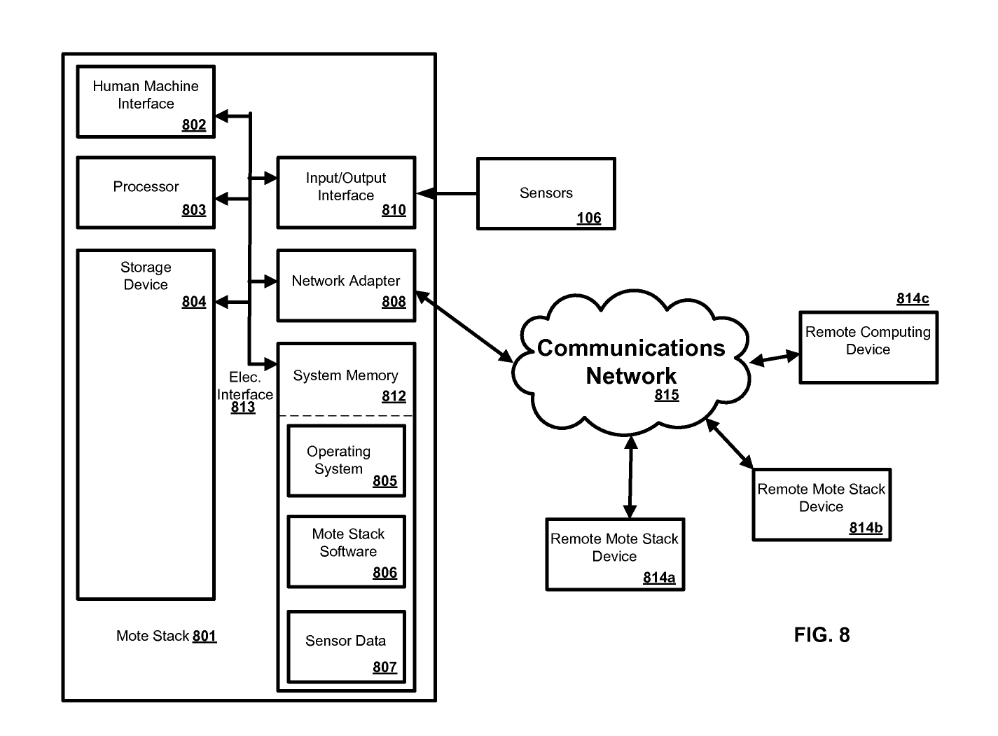

The system has been described above as comprised of units. One skilled in the art will appreciate that this is a functional description and that the respective functions can be performed by software, hardware, or a combination of software and hardware. A unit can be software, hardware, or a combination of software and hardware. The units can comprise the mote stack software 806 as illustrated in FIG. 8 and described below. In one exemplary aspect, the units can comprise a mote stack 801 as illustrated in FIG. 8 and described below.

FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a mote stack 801. The components of the mote stack 801 can comprise, but are not limited to, one or more processors or processing units 803, a system memory 812, and an electrical interface 813 that couples various system components including the processor 803 to the system memory 812. In the case of multiple processing units 803, the system can utilize parallel computing.

The electrical interface 813 interconnects each of the subsystems of the mote stack 801, including the processor 803, a storage device 804, an operating system 805, mote stack software 806, sensor data 807, a network adapter (e.g., radio) 808, system memory 812, an Input/Output Interface 810, and an optional human machine interface 802, each of which can be contained within one or more remote mote stack devices 814a,b at physically separate locations, connected through a communications network 115, in effect implementing a fully distributed system. The distributed system can also communicate via the communications network 115 with one or more remote computing devices 814c, such as a computer or server, for example.

The mote stack 801 typically comprises a variety of computer readable media. Exemplary readable media can be any available media that is accessible by the mote stack 801 and can comprise, for example and not meant to be limiting, both volatile and non-volatile media, removable and non-removable media. The system memory 812 can comprise computer readable media in the form of volatile memory, such as random access memory (RAM), and/or non-volatile memory, such as read only memory (ROM). The system memory 812 typically contains data such as sensor data 807 and/or program modules such as operating system 805 and mote stack software 806 that are immediately accessible to and/or are presently operated on by the processing unit 803.

In another aspect, the mote stack 801 can also comprise other removable/non-removable, volatile/non-volatile computer storage media. By way of example, FIG. 8 illustrates a mass storage device 804 which can provide non-volatile storage of computer code, computer readable instructions, data structures, program modules, and other data for the mote stack 801. For example and not meant to be limiting, a mass storage device 804 can be a hard disk, a removable magnetic disk, a removable optical disk, magnetic cassettes or other magnetic storage devices, flash memory cards such as MicroSD, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and mote stack software 806. Each of the operating system 805 and mote stack software 806 (or some combination thereof) can comprise elements of the programming and the mote stack software 806. Sensor data 807 can also be stored on the mass storage device 804.

In another aspect, the user can enter commands and information into the mote stack 801 via an input device (not shown). Examples of such input devices comprise, but are not limited to, a computer, a keyboard, pointing device (e.g., a “mouse”), a microphone, a joystick, tactile input devices such as gloves, and other body coverings, and the like. These and other input devices can be connected to the processing unit 803 via a human machine interface 802 that is coupled to the electrical interface 813.

Other peripheral devices can comprise components such as, for example, one or more sensors 106, which can be connected either directly to the mote stack 801 via Input/Output Interface 810, or through an ADC (not shown).

The mote stack 801 can operate in a networked environment using logical connections to one or more remote mote stacks 814a,b, or one or more remote computing devices 814c. By way of example, a remote computing device 814c can be a personal computer, portable computer, a server, a router, a network computer, a peer device or other common network node, and so on. Logical connections between the mote stack 801 and a remote mote stacks 814a,b or remote computing device 814c can be made via a communications network 815 such as, for example, a cellular communications network. Such network connections can be through a network adapter 808. A network adapter 808 can be implemented in both wired and wireless environments.

For purposes of illustration, application programs and other executable program components such as the operating system 805 are illustrated herein as discrete blocks, although it is recognized that such programs and components reside at various times in different storage components of the computing device 801, and are executed by the data processor(s). An implementation of mote stack software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory (e.g., MicroSD) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

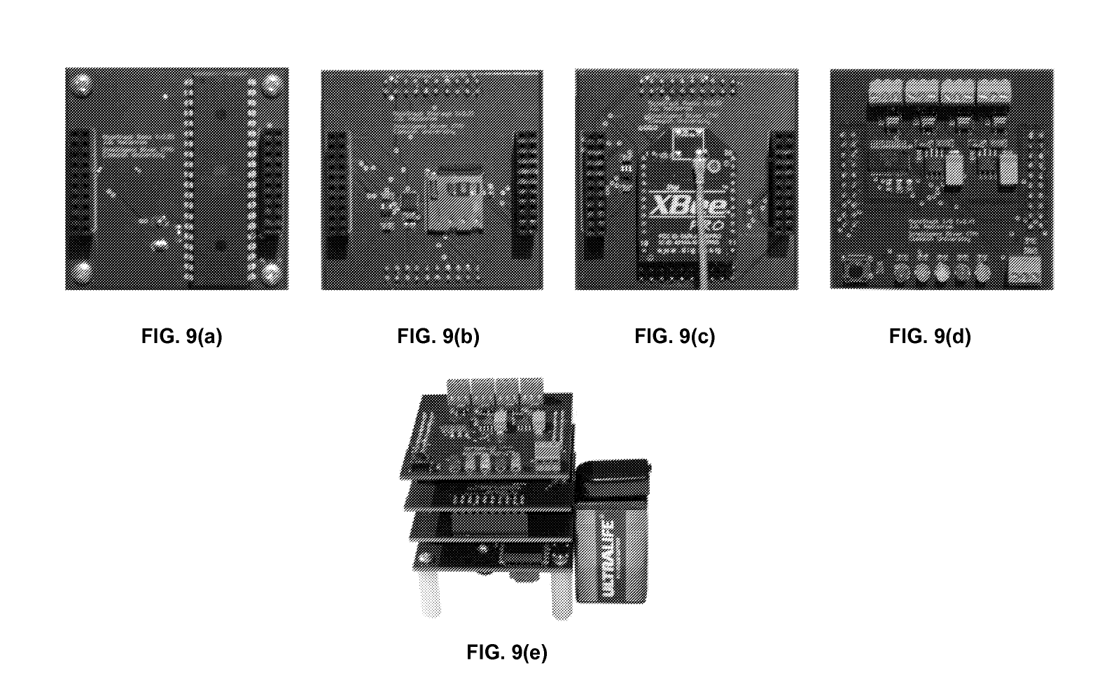

One embodiment of a stackable mote is shown in FIGS. 9a-9e comprising a processor board, a memory board, a radio board, and an interface board. FIG. 9a shows the processor board. In addition to providing basic power regulation and noise filtering, the board hosts a general purpose microcontroller (MCU). For example, in the design shown in FIG. 9a, an AVR microcontroller is used, though other MCUs may also be used. FIG. 9b shows a storage board which provides memory for data storage. For example, in the design shown in FIG. 9b, the board supports up to 32 GB of non-volatile storage on a removable, FAT-based microSD card, though other storage devices and formats may be used. FIG. 9c shows an embodiment of a radio board. Various wireless communications technologies may be used in different radio board embodiments including, for example, 3G/4G cellular, Wi-Fi (IEEE 802.11n), ZigBee, Bluetooth, WiMAX, etc. the employed communication technology can be selected and configured for a stackable mote based on coverage, foliage, penetration, data rate, and topology characteristics due to their operating frequency, power constraints, and radio techniques. For a given technology, the radio configuration (e.g., transmission power, amplifiers, antenna, etc.) can be adjusted to a limited extent according to the network coverage, transport capacity, and packet reception requirements. FIG. 9d shows an interface board. In addition to providing basic user interface elements (e.g., LEDs, tactile switches, headers, etc.), the board can expose standard digital interfaces (e.g., I²C, SPI, 1-Wire, etc.) for attaching external components and sensors. Power management software and power gating circuitry can also be included to provide improved energy conservation during idle periods. For example, in the design shown in FIG. 9d, the board provides a 14-bit ADC with an integrated programmable gain amplifier and can support 4 opto-isolated sensors.

FIG. 9e shows an assembled reference platform composed by stacking the four layers (processor board, memory board, radio board, and interface board). Additional boards may be added as appropriate, for instance, to provide support for high capacity nonvolatile storage, an SDI-12 board for aquatic sensor connectors, a solar board to provide a power source, and a cellular radio board. As configured in FIG. 9e, the device can operate in the field for over one year on a 9v battery when sampling digital and analog sensors every fifteen minutes. Component costs for this example, including the bare PCBs, are approximately $110.00 per unit when produced in 100-unit lots. The cost varies based on device configuration and drops substantially at larger volumes. Using a stackable implementation gives a user the ability to customize the device based on application-specific needs.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. Unless otherwise noted, the disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

What is claimed is:

1. An in situ collection and uplink infrastructure, said infrastructure system comprising:
at least one local sensor network comprising one or more configurable remote sensing devices, configured to transmit data to at least one communication network, the remote sensing devices comprising the following components,
a microcontroller unit, at least one sensor, an analog-to-digital converter, a power source, memory, and a radio transmitter;
wherein the components are located on a plurality of boards.

2. The system of claim 1, wherein the plurality of boards are stackable.

3. The system of claim 1, wherein the remote sensing devices further comprise a programmable gain amplifier.

4. The system of claim 1, wherein the remote sensing devices further comprise power management software and power gating hardware.

5. The system of claim 1, wherein the remote sensing devices further comprise an interface board which has the capability to communicate with a plurality of standard digital interfaces.

6. The system of claim 1, wherein the remote sensing devices are programmed to transmit the data to one or more long range networks.

7. The system of claim 1, wherein the remote sensing devices are programmed to transmit data asynchronously, allowing integration of new site installations.

8. The system of claim 1, wherein the remote sensing devices further comprise a receiver programmed to receive data asynchronously, allowing integration of new site installations.

9. The system of claim 1, wherein the components are exchangeable for substitute components according to user instruction.

10. The system of claim 1, wherein the remote sensing devices are programmed to transmit the data to a remote computing device.

11. A configurable remote sensing device comprising the following components: at least a microcontroller unit, at least one sensor, an analog-to-digital converter, a power source, memory, and a radio transmitter, wherein the components are located on a plurality of boards.

12. The device of claim 11, wherein the plurality of boards are stackable.

13. The device of claim 11, further comprising a programmable gain amplifier.

14. The device of claim 11, further comprising power management software and power gating hardware.

15. The device of claim 11, further comprising an interface board.

16. A method for low power, in-situ data collection, the method comprising:
deploying one or more configurable remote sensing devices, in an area to be monitored, configured to transmit data to at least one communication network, wherein the devices comprise the following components,
a microcontroller unit, at least one sensor, an analog-to-digital converter, a power source, memory, and a radio transmitter;
wherein the components are located on a plurality of boards, and monitoring data sensed by said sensors.

17. The method of claim 16, wherein the plurality of boards are stackable for placement in an area to be monitored.

18. The method of claim 16, further comprising programming power management software and implementing power gating hardware to extend the life of the power source, wherein the power gating hardware is attached to the remote sensing devices and the power gating software is stored in the memory.

19. The method of claim 16, further comprising using an interface board to support multiple sensors, wherein the interface board is attached to the remote sensing devices.

20. The method of claim 16, integrating new configurable remote sensing devices into an existing monitoring area, wherein the configurable remote sensing devices transmit data asynchronously, such that the previously deployed remote sensing devices do not need to be reconfigured.

21. The method of claim 16, integrating new configurable remote sensing devices into an existing monitoring area, wherein the configurable remote sensing devices further comprise a receiver capable of receiving data asynchronously, such that the previously deployed remote sensing devices do not need to be reconfigured.
